(19) United States
(12) Patent Application Publication
(10) Pub. No.: US 2023/0262558 A1
(43) Pub. Date: Aug. 17, 2023

(54) UE ROUTE SELECTION METHOD AND RELATED PRODUCTS

(71) Applicant: SPREADTRUM COMMUNICATIONS (TIANJIN) CO., LTD., Tianjin (CN)

(72) Inventor: Miao Miao, Tianjin (CN)

(21) Appl. No.: 18/014,240

(22) PCT Filed: Aug. 25, 2020
(86) PCT No.: PCT/CN2020/111071

§ 371 Date: Jan. 3, 2023

(30) Foreign Application Priority Data
Jul. 6, 2020 (CN) 202010640959.7

(51) Int. Cl. H04W 36/12; H04W 40/02

(52) U.S. Cl. CPC H04W 36/125; H04W 40/02; H04W 84/042

(57) ABSTRACT

Disclosed are a UE route selection method and related products, which are applied to an electronic device. The electronic device includes at least one device application. The method includes the following. An electronic device pre-configures a path descriptor parameter corresponding to each device application. When receiving a service enablement request from a target application, the electronic device determines a target path descriptor parameter according to the service enablement request, and then determines a target route according to the target path descriptor parameter.

### CROSS-REFERENCE TO RELATED APPLICATION(S)

This application is a National Stage of International Application No. PCT/CN2020/111071, field Aug. 25, 2020, which claims priority to Chinese Patent Application No. 2020106409597, filed Jul. 6, 2020, the entire disclosures of which are hereby incorporated by reference.

### TECHNICAL FIELD

The present application relates to the technical field of route selection, and in particular, to a user equipment (UE) route selection method and related products.

### BACKGROUND

A UE route selection policy is one policy information provided to the UE by the 5GC core network from a policy control function. The UE may use the policy to determine how to route a data outgoing path. With the UE route selection policy, the UE may determine whether a detected application can be associated with an already established protocol data unit session or whether a new protocol data unit session may be established.

After an operating system acquires path descriptor parameters associated with the application, and after the UE acquires the UE route selection policy rule list from the network, a corresponding route selection descriptor can be obtained through matching according to a rule evaluated by the UE route selection policy, and then a data route is selected according to the route path indicated by the route selection descriptor parameters. An important input data in the UE route selection policy rule is parameters in the path descriptor, and these parameters may be carried by an application when a network request is initiated or may be configured in other manners. How to acquire a path descriptor parameter and further perform UE routing becomes one of the problems to be solved nowadays.

### SUMMARY

In a first aspect, a UE route selection method is provide in an embodiment of the present application, which is applied to an electronic device, the electronic device including at least one device application. The method includes the following. A path descriptor parameter corresponding to each device application is pre-configured. A service enablement request from a target application is received. A target path descriptor parameter is determined according to the service enablement request. A target route is determined according to the target path descriptor parameter.

In a second aspect, an electronic device is provided in an embodiment of the present application. The electronic device includes a processor, a memory, a transceiver, and one or more programs, where the one or more programs are stored in the memory and configured to be executed by the processor, and the programs include instructions for executing steps in any method according to the first aspect of the embodiment of the present application.

In a third aspect, a non-transitory computer readable storage medium is provided in an embodiment of the present application. The computer readable storage medium stores a computer program for exchanging electronic data. The computer program enables a computer to execute a part or all of the steps described in any method in the second aspect of the embodiment of the present application.

### BRIEF DESCRIPTION OF THE DRAWINGS

To describe the technical solutions in the embodiments of the present application or in the prior art more clearly, the following briefly introduces the accompanying drawings required for describing the embodiments or the prior art. Apparently, the accompanying drawings in the following description show merely some embodiments of the present application, other drawings may also be obtained according to these drawings without creative efforts.

FIG. 1 is a schematic flowchart of a method for UE route selection according to an embodiment of the present application.

FIG. 2 is a schematic flowchart of another method for UE route selection according to an embodiment of the present application.

FIG. 3 is a schematic flowchart of another method for UE route selection according to an embodiment of the present application.

FIG. 4 is a schematic structural diagram of an electronic device according to an embodiment of the present application.

FIG. 5 is a block diagram of functional units of a UE route selection apparatus according to an embodiment of the present application.

### DETAILED DESCRIPTION

To make persons skilled in the art better understand the solutions of the present application, the following clearly and completely describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art based on the embodiments of the present application without creative efforts shall belong to the scope of protection of the present application.

The terms “first”, “second” and the like in the description and claims of the present application and the accompanying drawings are used for distinguishing different objects, rather than for describing a specific order. Furthermore, the terms “include”, “have” and any variations thereof are intended to cover exclusive inclusions. For example, a process, method, system, product or apparatus that includes a series of steps or units is not limited to the listed steps or units, but optionally further includes the steps or units not listed, or optionally further includes other steps or units inherent to the process, method, product or apparatus.

The embodiments of the present application will be described in detail below.

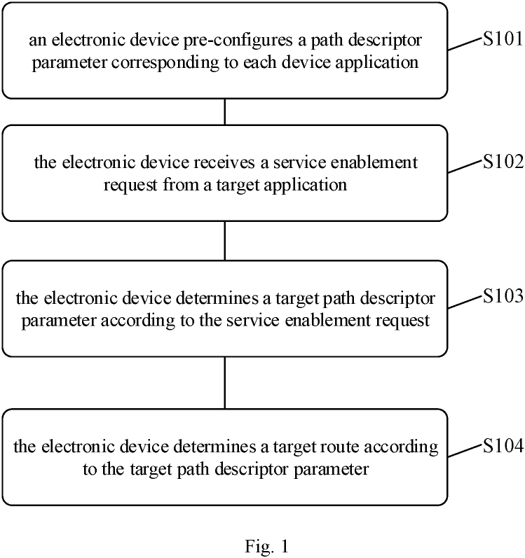

Please refer to FIG. 1, FIG. 1 is a schematic flowchart of a UE route selection method according to an embodiment of the present application, which is applied to an electronic device, where the electronic device includes at least one device application. The method includes the following.

S101, an electronic device pre-configures a path descriptor parameter corresponding to each device application.

The path descriptor parameter includes an application identifier (AID), an Internet Protocol (IP) descriptor, a data network name, a connection capability, and/or a fully qualified domain name.

S102, the electronic device receives a service enablement request from a target application, where the target application includes at least one application service.

S103, the electronic device determines a target path descriptor parameter according to the service enablement request, where the target path descriptor parameter is a part of parameters in the path descriptor parameter.

S104, the electronic device determines a target route according to the target path descriptor parameter.

It can be seen that in embodiments of the present application, a UE route selection method and related products are provided, which are applied to an electronic device, where the electronic device includes at least one device application. The method includes the following. An electronic device pre-configures a path descriptor parameter corresponding to each device application. When the electronic device receives a service enablement request from a target application, the terminal device determines a target path descriptor parameter according to the service enablement request, and then determines a target route according to the target path descriptor parameter. By optimally configuring a path descriptor parameter, the device application can use a service provided by an operator in different networks, without changing an existing interface between a device application and an operating system of an electronic device, which is beneficial to improving the portability and cross-platform performance of the device application, thereby being beneficial to improving the high efficiency and convenience of route selection, and providing a corresponding service to a user efficiently and conveniently.

In a possible example, the electronic device pre-configures the path descriptor parameter corresponding to each device application as follows. The electronic device acquires a service type of the device application. The electronic device determines a public land mobile network (PLMN) corresponding to each service type. The electronic device queries network slice information allocated by the PLMN to the service type. The electronic device determines the path descriptor parameter corresponding to the device application according to the network slice information.

The PLMN includes a network established and operated by a government or an operator approved by the government for the purpose of providing land mobile communication services to the public.

The network slice information includes network slice data that needs to be accessed by the service type.

In specific implementation, the service type of the device application obtained by the electronic device includes a video service and a voice service. The electronic device determines that the video service has subscribed to China Mobile® and China Unicom®, and the voice service has subscribed to China Mobile. The electronic device then queries the PLMN for network slice information allocated to the service type, determines that China Mobile allocates the same network slice Q1 to the video service and the voice service, and the China Unicom allocates a network slice Q2 to the video service. Finally, the electronic device determines the path descriptor parameter corresponding to the device application according to the network slice information.

It can be seen that in this example, the electronic device acquires a service type of the device application; the electronic device determines the subscribed PLMN corresponding to each service type; the electronic device queries network slice information allocated by the PLMN to the service type and determines a path descriptor parameter corresponding to the device application according to the network slice information; the electronic device determines a path descriptor parameter according to network slice information, and then performs route selection, which is beneficial to improving the accuracy of UE route selection.

In one possible example, the electronic device determines the target path descriptor parameter according to the service enablement request as follows. The electronic device determines that the service enablement request includes enabling a first service; the electronic device determines that the first service subscribes to a first PLMN and a second PLMN respectively; the electronic device acquires first network slice information and second network slice information; the electronic device determines a real-time PLMN currently used by the electronic device; and the electronic device determines the target path descriptor parameter according to the real-time PLMN, the first network slice information, and the second network slice information.

The first network slice information includes network slice data provided by the first PLMN to the first service, and the second network slice information includes network slice data provided by the second PLMN to the first service.

The real-time PLMN comprises China Mobile, China Telecom® and China Unicom.

In specific implementation, the electronic device determines that the service enablement request includes enabling a video service, and the electronic device determines that the video service subscribes to China Mobile and China Unicom respectively. The electronic device obtains first network slice information X1 provided by China Mobile for the video service and second network slice information X2 provided by China Unicom for the video service. The electronic device determines that a real-time PLMN currently used by the electronic device is China Mobile, and determines that the target path descriptor parameter is a path descriptor parameter in X2 according to the real-time PLMN, the first network slice information, and the second network slice information.

It can be seen that in this example, the electronic device determines that the service enablement request includes enabling a first service, and the electronic device determines that the first service respectively subscribes to a first PLMN and a second PLMN. The electronic device acquires first network slice information and second network slice information, and then the electronic device determines a real-time PLMN currently used by the electronic device. The electronic device determines the target path descriptor parameter according to the real-time PLMN, the first network slice information, and the second network slice information. This helps to efficiently and conveniently determine the path descriptor parameter required by the service to be activated or enabled, and further helps to improve the efficiency and accuracy of route selection.

In one possible example, the electronic device determines the target path descriptor parameter according to the real-time PLMN, the first network slice information, and the second network slice information as follows: when the electronic device determines that the real-time PLMN is the first PLMN, the electronic device determines the target path descriptor parameter according to the first network slice information; when the electronic device determines that the real-time PLMN is the second PLMN, the electronic device determines the target path descriptor parameter according to the second network slice information.

The first network slice information includes a target application identifier, an IP descriptor with which the target application subscribed to the first PLMN, a data network name, a connection capability, and/or a fully qualified domain name.

The second network slice information includes a target application identifier, an IP descriptor with which the target application has subscribed to the second PLMN, a data network name, a connection capability, and/or a fully qualified domain name.

In a specific implementation, when the electronic device determines that the real-time PLMN is China Mobile, the electronic device determines the target path descriptor parameter according to the first network slice information.

It can be seen that in this example, when determining that the real-time PLMN is the first PLMN, the electronic device determines the target path descriptor parameter according to the first network slice information; when determining that the real-time PLMN is the second PLMN, the electronic device determines the target path descriptor parameter according to the second network slice information. This facilitates that an application uses a service provided by an operator in a 5G network without changing an existing interface between an application and an operating system, thereby improving accuracy and effectiveness of route selection.

In one possible example, the electronic device determines the target path descriptor parameter according to the service enablement request as follows. The electronic device determines that the service enablement request includes enabling a first service and a second service. The electronic device determines that the first service respectively subscribes to a first PLMN and a second PLMN, and the second service respectively subscribes to the first PLMN and the second PLMN. The electronic device obtains third network slice information, fourth network slice information, and fifth network slice information. The electronic device determines a real-time PLMN currently used by the electronic device, and determines the target path descriptor parameter according to the real-time PLMN, the third network slice information, the fourth network slice information, and the fifth network slice information.

The third network slice information includes network slice data provided by the first PLMN to the first service and the second service, the fourth network slice information includes network slice data provided by the second PLMN to the first service, the fifth network slice information includes network slice data provided by the second PLMN to the second service.

In specific implementation, the electronic device determines that the service enablement request sent by the target application “Wechat®” includes enabling of a video service, a text service, and a game service, then the electronic device determines that the above service types all subscribe to China Mobile and China Unicom, these three services are required to access three different network slices when subscribing to China mobile, and these three services are allowed to access the same network slice when subscribing to China Unicom, in this case, the following parameters have been preset for Wechat in the OS.

Profile: traffic_descriptor. xml
< td appid=‘com. tencent. wechat’
osid=“Android”
mcc = ‘460’
mnc=“00”
DNN=“DNN”
connection_capabilities=“16” //it is assumed that 16 indicates that only the connection capability
supported is radio
/>
< td appid=‘com. tencent. wechat’
osid=“Android”
mcc = ‘460’
mnc=“00”
DNN (data network name)=“DNN2”
connection_capabilities=“32” //it is assumed that 16 indicates that only the connection capability
supported is vedio
/>
< td appid=‘com. tencent. wechat’
osid=“Android”
mcc = ‘460’
mnc=“00”
IP_address=‘192.168.3.45’ //it is assumed that both the IP address and the port number are the
address of the tencent game server
Port=“80”
connection_capabilities=“64” //it is assumed that 16 indicates that only the connection capability
supported is a game
/>
< td appid=‘com. tencent. wechat’
osid=“Android”
mcc = ‘460’
mnc=“01”
DNN=“DNN3”
/>

The target path descriptor parameter is determined according to the described parameter and the real-time PLMN.

It can be seen that in the present example, the electronic device determines that the service enablement request includes enabling a first service and a second service. The electronic device determines that the first service respectively subscribes to a first PLMN and a second PLMN, and the second service respectively subscribes to the first PLMN and the second PLMN. The electronic device obtains third network slice information, fourth network slice information, and fifth network slice information. The electronic device determines a real-time PLMN currently used by the electronic device, and determines the target path descriptor parameter according to the real-time PLMN, the third network slice information, the fourth network slice information, and the fifth network slice information. This helps to improve the efficiency and flexibility of UE route selection.

In one possible example, the electronic device determines the target path descriptor parameter according to the real-time PLMN, the third network slice information, the fourth network slice information, and the fifth network slice information as follows. When the electronic device determines that a real-time PLMN is the first PLMN, the electronic device determines the target path descriptor parameter according to the third network slice information. When the electronic device determines that the real-time PLMN is the second PLMN, the electronic device determines the target path descriptor parameter according to the fourth network slice information and the fifth network slice information.

In a specific implementation, the electronic device determines that the following parameters have been preset for the target application “Wechat” in the OS:

Profile: traffic_descriptor. xml
< td appid=‘com. tencent. wechat’
osid=“Android”
mcc = ‘460’
mnc=“00”
DNN=“DNN”
connection_capabilities=“16” //it is assumed that 16 indicates that only the connection capability
supported is radio
/>
< td appid=‘com. tencent. wechat’
osid=“Android”
mcc = ‘460’
mnc=“00”
DNN (data network name)=“DNN2”
connection_capabilities=“32” //it is assumed that 16 indicates that only the connection capability
supported is vedio
/>
< td appid=‘com. tencent. wechat’
osid=“Android”
mcc = ‘460’
mnc=“00”
IP_address=‘192.168.3.45’ //it is assumed that both the IP address and the port number are the
address of the tencent game server
Port=“80”
connection_capabilities=“64” //it is assumed that 16 indicates that only the connection capability
supported is a game
/>
< td appid=‘com. tencent. wechat’
osid=“Android”
mcc = ‘460’
mnc=“01”
DNN=“DNN3”
/>

Then, when the electronic device determines that the real-time PLMN is China Mobile, the electronic device wants to open a game service provided by Wechat for entertainment, and Wechat initiates a network request of which the connection capabilities is 64.

It can be seen that in this example, when determining that the real-time PLMN is the first PLMN, the electronic device determines the target path descriptor parameter according to the third network slice information; when determining that the real-time PLMN is the second PLMN, the electronic device determines the target path descriptor parameter according to the fourth network slice information and the fifth network slice information. This helps improve the convenience of determining network slice information, and further helps improve the efficiency and accuracy of UE route selection.

In a possible example, the electronic device pre-configures a path descriptor parameter corresponding to each device application, and the method further includes the following. The electronic device acquires a route selection descriptor allocated when a PLMN subscribes to the device application. The electronic device binds the route selection descriptor with an application identifier of the device application.

In a specific implementation, the electronic device acquires a route selection descriptor F allocated when China Telecom subscribes to the device application. The electronic device binds the route selection descriptor with the application identifier W of the device application, and directly determines a route selection policy without configuring a parameter in advance.

It can be seen that in this example, the electronic device acquires the route selection descriptor allocated when the PLMN signs up with the device application. The electronic device binds the route selection descriptor with an application identifier of the device application, so that the electronic device only needs to configure a part of the route selection descriptor, and then can perform route selection according to the application identifier, thereby improving the efficiency of UE route selection.

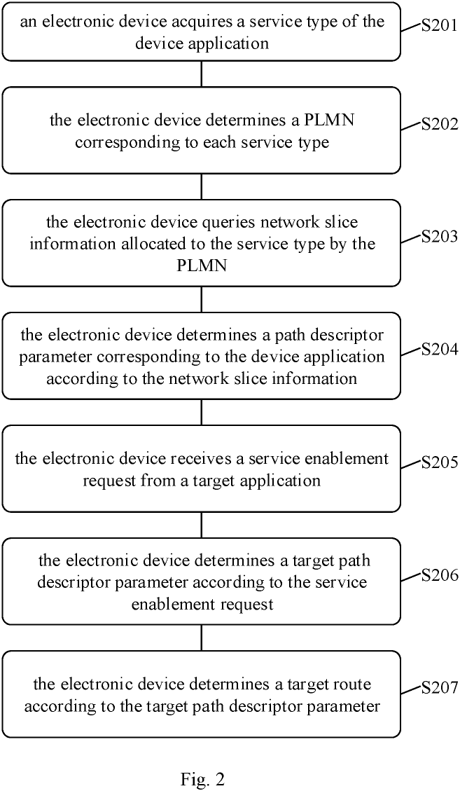

Similar to the embodiment shown in FIG. 1, referring to FIG. 2, FIG. 2 is a schematic flowchart of another method for UE route selection according to an embodiment of the present application, and the method is applied to an electronic device. As illustrated in figure, the UE route selection method includes the following.

S201, an electronic device acquires a service type of the device application.

S202, the electronic device determines a PLMN corresponding to each service type.

S203, the electronic device queries network slice information allocated to the service type by the PLMN.

S204, the electronic device determines a path descriptor parameter corresponding to the device application according to the network slice information.

S205, the electronic device receives a service enablement request from a target application.

S206, the electronic device determines a target path descriptor parameter according to the service enablement request.

S207, the electronic device determines a target route according to the target path descriptor parameter.

It can be seen that in embodiments of the present application, a UE route selection method and related products are provided, which are applied to an electronic device, where the electronic device includes at least one device application. The method includes the following. An electronic device pre-configures a path descriptor parameter corresponding to each device application. When the electronic device receives a service enablement request from a target application, the terminal device determines a target path descriptor parameter according to the service enablement request, and then determines a target route according to the target path descriptor parameter. By optimally configuring a path descriptor parameter, the device application can use a service provided by an operator in different networks, without changing an existing interface between a device application and an operating system of an electronic device, which is beneficial to improving the portability and cross-platform performance of the device application, thereby being beneficial to improving the high efficiency and convenience of route selection, and providing a corresponding service to a user efficiently and conveniently.

In addition, the electronic device acquires service types of the device application. The electronic device determines a subscribed PLMN corresponding to each of the service types. The electronic device queries network slice information allocated by the PLMN to the service type. The electronic device determines a path descriptor parameter corresponding to the device application according to the network slice information, determines a path descriptor parameter according to network slice information, and then performs route selection, which is beneficial to improving the accuracy of UE route selection.

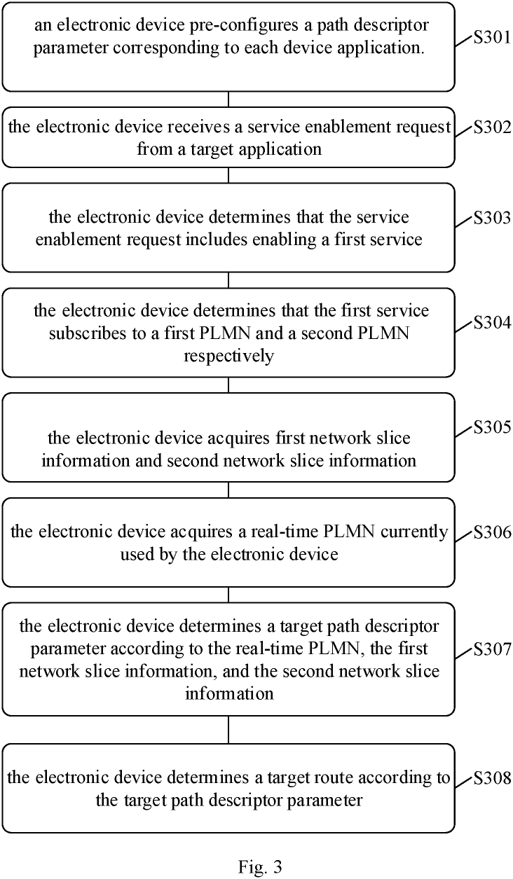

Similar to the embodiment shown in FIG. 1, referring to FIG. 3, FIG. 3 is a schematic flowchart of another method for UE route selection according to an embodiment of the present application, which is applied to an electronic device. As shown in the figure, the UE route selection method includes the following.

S301, an electronic device pre-configures a path descriptor parameter corresponding to each device application.

S302, the electronic device receives a service enablement request from a target application.

S303, the electronic device determines that the service enablement request includes enabling a first service.

S304, the electronic device determines that the first service subscribes to a first PLMN and a second PLMN respectively.

S305, the electronic device acquires first network slice information and second network slice information.

S306, the electronic device determines a real-time PLMN currently used by the electronic device.

S307, the electronic device determines a target path descriptor parameter according to the real-time PLMN, the first network slice information, and the second network slice information.

S308, the electronic device determines a target route according to the target path descriptor parameter.

It can be seen that in embodiments of the present application, a UE route selection method and related products are provided, which are applied to an electronic device, where the electronic device includes at least one device application. The method includes the following. An electronic device pre-configures a path descriptor parameter corresponding to each device application. When the electronic device receives a service enablement request from a target application, the terminal device determines a target path descriptor parameter according to the service enablement request, and then determines a target route according to the target path descriptor parameter. By optimally configuring a path descriptor parameter, the device application can use a service provided by an operator in different networks, without changing an existing interface between a device application and an operating system of an electronic device, which is beneficial to improving the portability and cross-platform performance of the device application, thereby being beneficial to improving the high efficiency and convenience of route selection, and providing a corresponding service to a user efficiently and conveniently.

In addition, the electronic device determines that the service enablement request includes enabling a first service and determines that the first service respectively subscribes to a first PLMN and a second PLMN. The electronic device acquires first network slice information and second network slice information, and then determines a real-time PLMN currently used by the electronic device. The electronic device determines the target path descriptor parameter according to the real-time PLMN, the first network slice information, and the second network slice information. This helps to efficiently and conveniently determine the path descriptor parameter required by the service to be enabled, and further helps to improve the efficiency and accuracy of route selection.

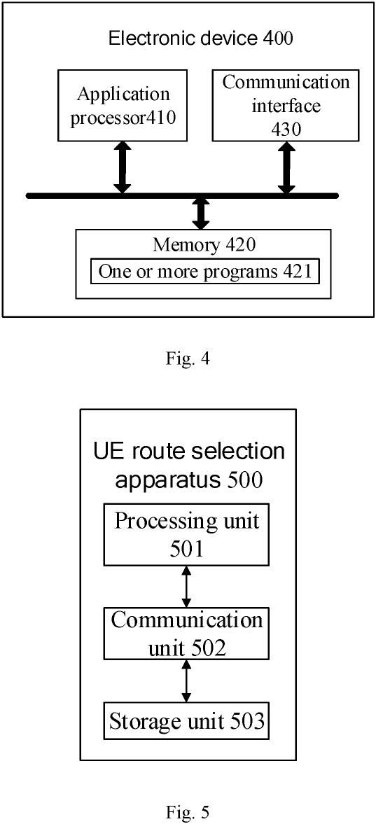

Similar to the embodiments shown in FIGS. 1, 2 and 3, referring to FIG. 4, FIG. 4 is a schematic structural diagram of an electronic device 400 according to an embodiment of the present application. As shown in the figure, the electronic device 400 includes an application processor 410, a memory 420, a communication interface 430, and one or more programs 421, where the one or more programs 421 are stored in the memory 420 and configured to be executed by the application processor 410. The one or more programs 421 include instructions for performing the following steps: pre-configuring a path descriptor parameter corresponding to each device application; receiving a service enablement request from a target application; determining a target path descriptor parameter according to the service enablement request; and determining a target route according to the target path descriptor parameter.

It can be seen that in embodiments of the present application, a UE route selection method and related products are provided, which are applied to an electronic device, where the electronic device includes at least one device application. The method includes the following. An electronic device pre-configures a path descriptor parameter corresponding to each device application. When the electronic device receives a service enablement request from a target application, the terminal device determines a target path descriptor parameter according to the service enablement request, and then determines a target route according to the target path descriptor parameter. By optimally configuring a path descriptor parameter, the device application can use a service provided by an operator in different networks, without changing an existing interface between a device application and an operating system of an electronic device, which is beneficial to improving the portability and cross-platform performance of the device application, thereby being beneficial to improving the high efficiency and convenience of route selection, and providing a corresponding service to a user efficiently and conveniently.

In a possible example, in terms of pre-configuring the path descriptor parameter corresponding to each device application, the instructions in the programs are used for performing the following operations: acquiring a service type(s) of the device application; determining a PLMN corresponding to each service type; querying network slice information allocated to the service type by the PLMN; and determining a path descriptor parameter corresponding to the device application according to the network slice information.

In a possible example, in terms of determining the target path descriptor parameter according to the service enablement request, the instructions in the programs are used for performing the following operations: determining that the service enablement request includes enabling a first service; determining that the first service subscribes to a first PLMN and a second PLMN, respectively; acquiring first network slice information and second network slice information, where the first network slice information includes network slice data provided by the first PLMN to the first service, and the second network slice information includes network slice data provided by the second PLMN to the first service; determining a real-time PLMN currently used by the electronic device; and determining the target path descriptor parameter according to the real-time PLMN, the first network slice information, and the second network slice information.

In a possible example, in terms of determining the target path descriptor parameter according to the real-time PLMN, the first network slice information, and the second network slice information, the instructions in the programs are used for performing the following operations: when the real-time PLMN determined is the first PLMN, determining the target path descriptor parameter according to the first network slice information; when the real-time PLMN determined is the second PLMN, determining the target path descriptor parameter according to the second network slice information.

In a possible example, in terms of determining the target path descriptor parameter according to the service enablement request, the instructions in the programs are used for performing the following operations: determining that the service enablement request includes enabling a first service and a second service; determining that the first service subscribes to a first PLMN and a second PLMN respectively and the second service subscribes to the first PLMN and the second PLMN respectively; acquiring third network slice information, fourth network slice information and fifth network slice information, where the third network slice information includes network slice data provided by the first PLMN for the first service and the second service, the fourth network slice information includes network slice data provided by the second PLMN to the first service, the fifth network slice information includes network slice data provided by the second PLMN to the second service; determining a real-time PLMN currently used by the electronic device; and determining the target path descriptor parameter according to the real-time PLMN, the third network slice information, the fourth network slice information, and the fifth network slice information.

In a possible example, in terms of determining the target path descriptor parameter according to the real-time PLMN, the third network slice information, the fourth network slice information, and the fifth network slice information, the instructions in the programs are used for performing the following operations: when the real-time PLMN determined is the first PLMN, determining the target path descriptor parameter according to the third network slice information; when the real-time PLMN determined is the second PLMN, determining the target path descriptor parameter according to the fourth network slice information and the fifth network slice information.

In a possible example, in terms of pre-configuring the path descriptor parameter corresponding to each device application, the instructions in the programs are further specifically configured to perform the following operations: acquiring a route selection descriptor allocated when a PLMN subscribes to the device application, and binding the route selection descriptor with an application identifier of the device application.

The foregoing describes the solutions of the embodiments of the present application mainly from the aspect of a process of a method executed. It can be understood that, in order to realize the described functions, the electronic device contains hardware structures and/or software modules corresponding to the execution of various functions. A person skilled in the art should be easily aware that, in combination with the units and algorithm steps of each example described in the embodiments provided in this specification, the present application may be implemented by hardware or a combination of hardware and computer software. Whether a certain function is executed by means of hardware or computer software to drive the hardware depends on specific applications and design constraint conditions of the technical solutions. A person skilled in the art may use different methods to implement the described functions for each specific application, but the implementation shall not be considered as going beyond the scope of the present application.

In the embodiments of the present application, functional units of an electronic device may be divided according to the foregoing method example. For example, functional units may be divided corresponding to respective functions, or two or more functions may be integrated into one processing unit. The integrated unit may be implemented in a form of hardware, and may also be implemented in a form of a software functional unit. It should be noted that the division of the units in the embodiments of the present application is schematic, which is merely logical function division and may be other division in actual implementation.

FIG. 5 is a functional block diagram of a UE route selection apparatus 500 involved in an embodiment of the invention. The UE route selection apparatus 500 is applied to an electronic device. The UE route selection apparatus includes a processing unit 501, a communication unit 502, and a storage unit 503. The communication unit can be a transceiver.

The processing unit 501 is configured to: pre-configure a path descriptor parameter corresponding to each device application; receive a service enablement request from a target application; determine a target path descriptor parameter according to the service enablement request; and determine a target route according to the target path descriptor parameter.

It can be seen that in embodiments of the present application, a UE route selection method and related products are provided, which are applied to an electronic device, where the electronic device includes at least one device application. The method includes the following. An electronic device pre-configures a path descriptor parameter corresponding to each device application. When the electronic device receives a service enablement request from a target application, the electronic device determines a target path descriptor parameter according to the service enablement request, and then determines a target route according to the target path descriptor parameter. By optimally configuring a path descriptor parameter, the device application can use a service provided by an operator in different networks, without changing an existing interface between a device application and an operating system of an electronic device, which is beneficial to improving the portability and cross-platform performance of the device application, thereby being beneficial to improving the high efficiency and convenience of route selection, and providing a corresponding service to a user efficiently and conveniently.

It should be understood that, because the method embodiments and the apparatus embodiments are different presentation forms of the same technical concept, the content of the method embodiments in the present application should be synchronously adapted to the apparatus embodiments, which is not described herein again.

In a possible example, in terms of pre-configuring the path descriptor parameter corresponding to each device application, the processing unit 501 is specifically configured to: obtain a service type(s) of the device application; determine a PLMN corresponding to each service type; query network slice information allocated to the service type by the PLMN; and determine a path descriptor parameter corresponding to the device application according to the network slice information.

In a possible example, in terms of determining the target path descriptor parameter according to the service enablement request, and the processing unit 501 is specifically configured to: determine that the service enablement request includes enabling a first service; determine that the first service subscribes to a first PLMN and a second PLMN, respectively; acquire first network slice information and second network slice information, where the first network slice information includes network slice data provided by the first PLMN to the first service, and the second network slice information includes network slice data provided by the second PLMN to the first service; determine a real-time PLMN currently used by the electronic device; and determine the target path descriptor parameter according to the real-time PLMN, the first network slice information, and the second network slice information.

In a possible example, in terms of determining the target path descriptor parameter according to the real-time PLMN, the first network slice information, and the second network slice information, the processing unit 501 is specifically configured to: when the real-time PLMN determined is the first PLMN, determine the target path descriptor parameter according to the first network slice information; when the real-time PLMN determined is the second PLMN, determine the target path descriptor parameter according to the second network slice information.

In a possible example, in terms of determining the target path descriptor parameter according to the service enablement request, the processing unit 501 is specifically configured to: determine that the service enablement request includes enabling a first service and a second service; determine that the first service subscribes to a first PLMN and a second PLMN respectively and the second service subscribes to the first PLMN and the second PLMN respectively; acquire third network slice information, fourth network slice information and fifth network slice information, where the third network slice information includes network slice data provided by the first PLMN for the first service and the second service, the fourth network slice information includes network slice data provided by the second PLMN to the first service, the fifth network slice information includes network slice data provided by the second PLMN to the second service; determine a real-time PLMN currently used by the electronic device; and determine the target path descriptor parameter according to the real-time PLMN, the third network slice information, the fourth network slice information, and the fifth network slice information.

In a possible example, in terms of determining the target path descriptor parameter according to the real-time PLMN, the third network slice information, the fourth network slice information, and the fifth network slice information, the processing unit 501 is specifically configured to: when the real-time PLMN determined is the first PLMN, determine the target path descriptor parameter according to the third network slice information; when the real-time PLMN determined is the second PLMN, determine the target path descriptor parameter according to the fourth network slice information and the fifth network slice information.

In a possible example, in terms of pre-configuring the path descriptor parameter corresponding to each device application, the processing unit 501 is specifically further configured to: acquire a route selection descriptor allocated when a PLMN subscribes to the device application, and bind the route selection descriptor with an application identifier of the device application.

Embodiments of the present application further provide a computer storage medium. The computer storage medium stores a computer program for exchanging electronic data. The computer program enables a computer to execute some or all of the steps of any method described in the foregoing method embodiments. The computer comprises an electronic device.

Embodiments of the present application further provide a computer program product. The computer program product includes a non-transitory computer-readable storage medium storing a computer program. The computer program is operable to enable a computer to execute a part or all of the steps of any method described in the foregoing method embodiments. The computer program product may be a software installation package, and the computer includes an electronic device.

It should be noted that, for brevity of description, the foregoing method embodiments are described as a series of actions. However, those skilled in the art should understand that the present application is not limited to the described order of actions. According to the present application, some steps may be performed in another order or simultaneously. Secondly, those skilled in the art should also know that the embodiments described in the description are all preferred embodiments, and the involved actions and modules are not necessarily required in the present application.

In the above embodiments, the description of each embodiment has its emphasis, and the part not described in detail in a certain embodiment may refer to the relevant description of other embodiments.

In the embodiments provided in the present application, it should be understood that the disclosed apparatus may be implemented in other manners. For example, the apparatus embodiments described above are merely exemplary. For example, division of the foregoing units is merely logical function division, and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, they may be located in one position, or may be distributed on a plurality of network elements. A part or all of the units may be selected according to actual requirements to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, and may also be implemented in a form of a software functional unit.

If the integrated unit is implemented in a form of a software functional unit and sold or used as an independent product, the integrated unit may be stored in a computer readable memory. Based on such an understanding, the technical solutions of the present application essentially, or the part contributing to the prior art, or all or a part of the technical solutions may be implemented in the form of a software product. The computer software product is stored in a memory, and includes several instructions for instructing a computer device (which may be a personal computer, a server, a network device, or the like) to perform all or a part of the steps of the methods described in the embodiments of the present application. The foregoing memory includes any medium that can store program codes, such as a USB flash disk, a read-only memory (ROM), a random access memory (RAM), a mobile hard disk, a magnetic disk, or an optical disk.

Persons of ordinary skill in the art should understand that all or part of the steps of the methods in the embodiments may be implemented by a program instructing relevant hardware. The program may be stored in a computer readable memory, and the memory may include a flash memory disk, a read-only memory (Read-Only Memory, ROM for short), a random access memory (Random Access Memory, RAM for short), a magnetic disk, or an optical disk.

The embodiments of the present application are introduced in detail above, specific examples are used in the present application to set forth the principle and embodiments of the present application, and the description of the above embodiments is only used to help understand the method of the present application and the core idea thereof. Meanwhile, a person of ordinary skill in the art may make modifications to the specific implementations and application scopes according to the idea of the present application. In conclusion, the content of the description shall not be construed as a limitation to the present application.

What is claimed is:

1. A user equipment (UE) route selection method, applied to an electronic device, wherein the electronic device comprises at least one device application, the method comprising:
pre-configuring a path descriptor parameter corresponding to each device application;
receiving a service enablement request from a target application;
determining a target path descriptor parameter according to the service enablement request; and
determining a target route according to the target path descriptor parameter.

2. The method according to claim 1, wherein pre-configuring the path descriptor parameter corresponding to each device application comprises:
obtaining at least one service type of the device application;
determining a public land mobile network (PLMN) corresponding to each service type;
querying network slice information allocated to the service type by the PLMN; and
determining the path descriptor parameter corresponding to the device application according to the network slice information.

3. The method according to claim 2, wherein determining the target path descriptor parameter according to the service enablement request comprises:
determining that the service enablement request comprises enabling a first service;
determining that the first service subscribes to a first PLMN and a second PLMN respectively;
acquiring first network slice information and second network slice information, wherein the first network slice information comprises network slice data provided by the first PLMN to the first service, and the second network slice information comprises network slice data provided by the second PLMN to the first service;
determining a real-time PLMN currently used by the electronic device; and
determining the target path descriptor parameter according to the real-time PLMN, the first network slice information, and the second network slice information.

4. The method according to claim 3, wherein determining the target path descriptor parameter according to the real-time PLMN, the first network slice information, and the second network slice information comprises one of:
determining the target path descriptor parameter according to the first network slice information, in response to the real-time PLMN determined being the first PLMN;
determining the target path descriptor parameter according to the second network slice information, in response to the real-time PLMN determined being the second PLMN.

5. The method according to claim 2, wherein determining the target path descriptor parameter according to the service enablement request comprises:
determining that the service enablement request comprises enabling a first service and a second service;
determining that the first service subscribes to a first PLMN and a second PLMN respectively and the second service subscribes to the first PLMN and the second PLMN respectively;
acquiring third network slice information, fourth network slice information, and fifth network slice information, wherein the third network slice information comprises network slice data provided by the first PLMN to the first service and the second service, the fourth network slice information comprises network slice data provided by the second PLMN to the first service, the fifth network slice information comprises network slice data provided by the second PLMN to the second service;
determining a real-time PLMN currently used by the electronic device; and
determining the target path descriptor parameter according to the real-time PLMN, the third network slice information, the fourth network slice information, and the fifth network slice information.

6. The method according to claim 5, wherein determining the target path descriptor parameter according to the real-time PLMN, the third network slice information, the fourth network slice information, and the fifth network slice information comprises one of:
determining the target path descriptor parameter according to the third network slice information, in response to the real-time PLMN determined being the first PLMN;
determining the target path descriptor parameter according to the fourth network slice information and the fifth network slice information, in response to the real-time PLMN determined being the second PLMN.

7. The method according to claim 1, wherein pre-configuring the path descriptor parameter corresponding to each device application further comprises:
acquiring a route selection descriptor which is allocated when a PLMN subscribes to the device application; and
binding the route selection descriptor with an application identifier of the device application.

8. (canceled)

9. An electronic device, comprising a processor, a memory, a transceiver, and one or more programs, wherein the one or more programs are stored in the memory and configured to be executed by the processor to:
pre-configure a path descriptor parameter corresponding to each device application;
cause the transceiver to receive a service enablement request from a target application:
determine a target path descriptor parameter according to the service enablement request; and
determine a target route according to the target path descriptor parameter.

10. A non-transitory computer readable storage medium, storing a computer program for exchanging electronic data, wherein the computer program enables a computer to execute:
pre-configuring a path descriptor parameter corresponding to each device application:
receiving a service enablement request from a target application:
determining a target path descriptor parameter according to the service enablement request; and
determining a target route according to the target path descriptor parameter.

11. The electronic device according to claim 9, wherein the processor configured to pre-configure the path descriptor parameter corresponding to each device application is configured to:
obtain at least one service type of the device application;
determine a public land mobile network (PLMN) corresponding to each service type;
query network slice information allocated to the service type by the PLMN; and
determine the path descriptor parameter corresponding to the device application according to the network slice information.

12. The electronic device according to claim 11, wherein the processor configured to determine the target path descriptor parameter according to the service enablement request is configured to:
determine that the service enablement request comprises enabling a first service;
determine that the first service subscribes to a first PLMN and a second PLMN respectively;
acquire first network slice information and second network slice information, wherein the first network slice information comprises network slice data provided by the first PLMN to the first service, and the second network slice information comprises network slice data provided by the second PLMN to the first service;
determine a real-time PLMN currently used by the electronic device; and
determine the target path descriptor parameter according to the real-time PLMN, the first network slice information, and the second network slice information.

13. The electronic device according to claim 12, wherein the processor is configured to:
determine the target path descriptor parameter according to the first network slice information, in response to the real-time PLMN determined being the first PLMN;
determine the target path descriptor parameter according to the second network slice information, in response to the real-time PLMN determined being the second PLMN.

14. The electronic device according to claim 11, wherein the processor configured to determine the target path descriptor parameter according to the service enablement request is configured to:
determine that the service enablement request comprises enabling a first service and a second service;
determine that the first service subscribes to a first PLMN and a second PLMN respectively and the second service subscribes to the first PLMN and the second PLMN respectively;
acquire third network slice information, fourth network slice information, and fifth network slice information, wherein the third network slice information comprises network slice data provided by the first PLMN to the first service and the second service, the fourth network slice information comprises network slice data provided by the second PLMN to the first service, the fifth network slice information comprises network slice data provided by the second PLMN to the second service;
determine a real-time PLMN currently used by the electronic device; and
determine the target path descriptor parameter according to the real-time PLMN, the third network slice information, the fourth network slice information, and the fifth network slice information.

15. The electronic device according to claim 14, wherein the processor is configured to:
determine the target path descriptor parameter according to the third network slice information, in response to the real-time PLMN determined being the first PLMN;
determine the target path descriptor parameter according to the fourth network slice information and the fifth network slice information, in response to the real-time PLMN determined being the second PLMN.

16. The method according to claim 9, wherein pre-configuring the path descriptor parameter corresponding to each device application further comprises:
acquiring a route selection descriptor which is allocated when a PLMN subscribes to the device application; and
binding the route selection descriptor with an application identifier of the device application.

17. The electronic device according to claim 10, wherein in terms of pre-configuring the path descriptor parameter corresponding to each device application, the computer program enables the computer to execute:
obtaining at least one service type of the device application;
determining a public land mobile network (PLMN) corresponding to each service type;
querying network slice information allocated to the service type by the PLMN; and
determining the path descriptor parameter corresponding to the device application according to the network slice information.

18. The non-transitory computer readable storage medium according to claim 17, wherein in terms of determining the target path descriptor parameter according to the service enablement request, the computer program enables the computer to execute:
determining that the service enablement request comprises enabling a first service;
determining that the first service subscribes to a first PLMN and a second PLMN respectively;
acquiring first network slice information and second network slice information, wherein the first network slice information comprises network slice data provided by the first PLMN to the first service, and the second network slice information comprises network slice data provided by the second PLMN to the first service;
determining a real-time PLMN currently used by the electronic device; and
determining the target path descriptor parameter according to the real-time PLMN, the first network slice information, and the second network slice information.

19. The non-transitory computer readable storage medium according to claim 18, wherein in terms of determining the target path descriptor parameter according to the service enablement request, the computer program enables the computer to execute:
determining the target path descriptor parameter according to the first network slice information, in response to the real-time PLMN determined being the first PLMN;
determining the target path descriptor parameter according to the second network slice information, in response to the real-time PLMN determined being the second PLMN.

20. The non-transitory computer readable storage medium according to claim 19, wherein in terms of determining the target path descriptor parameter according to the service enablement request, the computer program enables the computer to execute:
determining that the service enablement request comprises enabling a first service and a second service;
determining that the first service subscribes to a first PLMN and a second PLMN respectively and the second service subscribes to the first PLMN and the second PLMN respectively;
acquiring third network slice information, fourth network slice information, and fifth network slice information, wherein the third network slice information comprises network slice data provided by the first PLMN to the first service and the second service, the fourth network slice information comprises network slice data provided by the second PLMN to the first service, the fifth network slice information comprises network slice data provided by the second PLMN to the second service;
determining a real-time PLMN currently used by the electronic device; and
determining the target path descriptor parameter according to the real-time PLMN, the third network slice information, the fourth network slice information, and the fifth network slice information.

21. The non-transitory computer readable storage medium according to claim 20, wherein in terms of determining the target path descriptor parameter according to the real-time PLMN, the third network slice information, the fourth network slice information, and the fifth network slice information, the computer program enables the computer to execute one of:
determining the target path descriptor parameter according to the third network slice information, in response to the real-time PLMN determined being the first PLMN;
determining the target path descriptor parameter according to the fourth network slice information and the fifth network slice information, in response to the real-time PLMN determined being the second PLMN.
